(19) United States
(12) Patent Application Publication
(10) Pub. No.: US 2026/0026517 A1
(43) Pub. Date: Jan. 29, 2026

(54) TRANSPORT DEVICE FOR TRANSPORTING ELONGATED CASINGS FILLED WITH FOOD MASS, AND RELATED SEPARATING DEVICE

(71) Applicant: VEMAG Maschinenbau GmbH, Verden (DE)

(72) Inventor: Gerhard Franz, Langwedel (DE)

(21) Appl. No.: 19/053,932

(22) Filed: Feb. 14, 2025

(30) Foreign Application Priority Data
Feb. 19, 2024 (DE) 102024104580.9

(51) Int. Cl. A22C 11/00

(52) U.S. Cl. CPC A22C 11/008

(57) ABSTRACT

A transport device transports portions made of elongated casings filled with food mass. The transport device includes a base body, two transport units respectively connected to the base body via a bearing, and the transport units respectively having a drivable transport belt. At least one, in particular both bearings are designed as pivot bearings having an axis of rotation about which the respective transport belt unit is mounted to be pivotable with respect to the base body. The transport belts are movable toward one another and/or away from one another by pivoting about the at least one axis of rotation.

### CROSS-REFERENCE TO RELATED APPLICATION

This application claims priority to German Patent Application No. 102024104580.9, filed Feb. 19, 2024. The above-mentioned patent application is incorporated herein by reference in its entirety.

### TECHNICAL FIELD

The invention relates to a transport device for transporting portions made of elongated casings filled with food mass, in particular sausage portions or a string of sausage portions.

### BACKGROUND

These types of transport devices are known from the prior art. They are used, for example, in separating devices to feed strings of sausage portions to a separating device, for example a knife, and then to correspondingly transport the separated sausage portions away. The challenge arises here in that sausage portions, which are usually produced by filling natural casings, have natural differences in diameter. These types of differences are also designated as deviations in caliber. In addition to these natural deviations in caliber, so-called deviations in shape are observed in practice, which may appear due to downstream processes or also during transport. For example, sausage portions may have flattened areas or a so-called candle shape. Furthermore, sausage portions may assume different curvatures, which likewise contribute to the deviations in shape. The deviations, described with respect to the caliber and shape of the sausage portions to be transported, lead to the fact that the transport of these types of sausage portions is technically challenging.

Transport devices, previously known from the prior art, are typically adjusted for a certain caliber, so that a defined spacing is defined between the transport belts. Due to the deviations in caliber and shape, this may lead to slippage, that may occur during transport, due to the fact that the transport belts used for transport apply too little force to the sausage portions. The transport belts slip to some extent. In some cases, a blockage of transport belts and the relevant drives, or an increased power demand, has been additionally observed, when, in order to prevent slippage, the transport belts are adjusted too narrowly for the sausage portion to be transported. In this case, a significant mechanical load results for the drive components and for the transport belts themselves. Friction at the transport belts and load on the drive components is increased, which may negatively effect the service life of the components.

In order to overcome this problems, it is known from the prior art to use concave rollers in the area of the transport belt guides. The elasticity of the transport belts may hereby be leveraged, so that a caliber change presses the transport belts into a concave cavity between the backs of the belts and the concave rollers. However, it has been shown that the size range to compensate for the deviations in shape and caliber is often not sufficiently dimensioned. In addition, the elasticity behavior of these types of transport belts does not lead to sufficient security, so that slippage and excessive load on the drive components may be prevented.

As an alternative solution, a spring-loaded transport belt guide is known from the prior art, in which the transport belts are guided relatively linearly to one another. However, the disadvantage here is that the linear guiding has a high inertia and is sluggish due to friction. Therefore, this may only insufficiently compensate for deviations in caliber or shape. In addition, the guides increase the mechanical complexity in direct proximity to the separating element of the separating device, so that the device as a whole is difficult to clean. As stringent requirements exist in terms of food hygiene during the transport of sausage portions or a string of sausage portions, linear guides may have deficits in this respect.

It is therefore the object of the underlying invention to at least largely overcome the known disadvantages of the prior art. In particular, a transport device has been specified, which enables a secure transport of sausage portions or of a string of sausage portions, even in the case of deviations in caliber and shape, and additionally may be used for different sausage calibers, and is also particularly easy to clean.

### SUMMARY

The problem is solved by a transport device of the type listed at the outset, e.g., having a base body, in particular a machine base, two transport units, the transport unit being respectively connected to the base body via a bearing, and the transport units respectively having a drivable transport belt, the transport belts of the transport units being arranged adjacent to one another in such a way that they define a receiving space between themselves for receiving and for transporting the portions in a transport direction. At least one, in particular both bearings are designed as pivot bearings, the at least one pivot bearing having an axis of rotation about which the respective transport belt unit is pivotably mounted with respect to the base body, the transport belts of the adjacent transport devices being movable toward one another and/or away from one another due to the pivoting about the at least one axis of rotation.

The invention exploits the knowledge that, due to the design of the at least one, in particular both bearings as a pivot bearing or pivot bearings, a potential is created for guaranteeing a symmetrical movement sequence, starting from the middle, of the transport belts toward and away from one another. A targeted adjustment with respect to the expected caliber of the sausage portions to be processed may be achieved via an adaptation of the spacing of the transport belts with respect to one another by the pivot bearings. Furthermore, it may be achieved that the transport belts press on the sausage portions with a largely constant force. In addition, a transport device of this type offers basic hygiene advantages. Because the axes of rotation of the transport units are arranged spaced apart from the transport belts, the area under the transport belts is open and easily accessible for cleaning procedures.

The pivot bearings of the transport units are preferably positioned so that these are spaced as far as possible from the transport belts, such that, despite the fact that the transport units are pivoted about the respective axes of rotation, a virtually parallel guiding with little angular error is achieved in the area of the transport belts. The pivot bearings are preferably arranged laterally on the base body, by which the cleanability of the arrangement is facilitated.

According to one embodiment, the transport units are arranged adjacent to one another. The axes of rotation of the adjacent transport units are preferably arranged parallel to one another. In this way, it may be advantageously implemented that the transport belts of the transport units are movable toward one another and/or away from one another due to the pivoting about the axis of rotation.

According to one embodiment, a drive motor is assigned to each of the transport units. The drive motor is preferably embedded in the base body. In this way, the transport belts of the transport units are drivable independently of one another. For example, a synchronous motor, in particular a synchronous servomotor, may be provided as a drive motor.

According to one embodiment, the transport units each have an arm section, which spaces the transport belt apart from the pivot bearing, in particular, a spacing between the axis of rotation of the pivot bearing and a lower edge of the assigned transport belt corresponding to X to Y times a width of the transport belt. Due to the spacing of the transport belt apart from the pivot bearing by the arm section, it is achieved that the transport belts move to the greatest extent parallel to one another or have only a low angular error when the transport belts are moved toward and away from one another. By this, the transport behavior of the transport device is improved overall. The sausage portions to be transported also then remain in slippage-free contact with the transport belts when these are pivoted about the respective axis of rotation. The specified ratio has thereby proven to be particularly suited for ensuring a slippage-free transport of the sausage portions.

According to one embodiment, the adjacent transport units are coupled to one another via a coupling device. In this way, a symmetrical motion sequence, starting from the middle, may be guaranteed, wherein adjustment devices like stops, or biasing devices like springs, only have to be present just once and may act on both transport units by the coupling device.

According to one embodiment, a biasing device, assigned to the coupling device, is equipped to bias the coupled transport units in the direction of the receiving space. In this way, the transport units and thus the transport belts are pressed in the direction of the sausage portions to be transported. The flow of forces thereby runs from the transport belt unit, which is set using spring biasing, across the coupling device to the adjacent transport belt unit. As soon as a deviation in shape or caliber occurs, starting from the smallest dimension in the string of sausage portions to be transported, this would result in a pressing outward of the transport units and thus also the transport belts. The biasing device ensures that the sausage portions to be transported are pressed against the transport belts with a defined force. By this, a secure contact between the sausage portions and the transport belts is established, such that forces may be securely transferred from the transport belts to the sausage portions. Deviations of the sausage portions with respect to shape or caliber may thus be compensated for and ultimately slippage-free transport, or a transport with little slippage may be guaranteed.

According to one embodiment, the coupling device has an adjustable stop which is equipped to adjust an outlet spacing of the transport belts to one another. The adjustment of the stop facilitates the adaptation of the outlet spacing of the transport belts with respect to one another, such that these may be adapted to the caliber, i.e., to the diameter of the sausage portions to be transported. The outlet spacing of the transport belts is preferably selected by the stop so that the outlet spacing is slightly undersized with respect to the smallest expected caliber or diameter of the sausage portion to be transported.

According to one embodiment, by pivoting about the axes of rotation, the transport units are pivotable away from one another out of a transport position into a cleaning position, in which a spacing between the adjacent transport belts is increased. In the cleaning position, the access to the under side of the transport units or the transport belts is further improved.

According to one embodiment, the machine base or the base body is configured for this purpose as pyramid shaped, such that the base body has its highest elevation adjacent to the transport direction of the portions and drops off on the sides—transverse to the transport direction—in the manner of a pyramid. In this way, it is prevented that particles of the casings or sausage portions themselves accumulate on the machine base on a large scale. In addition, the cleanability of the machine base is facilitated.

According to one embodiment, a crank, which acts on the coupling device, is provided for pivoting between the cleaning position and the transport position. In this way, the change of states between the transport position and the cleaning position and vice versa may be established in a particularly operator friendly way.

According to one embodiment, the transport device has a sealing element, which seals a feed through of the pivot bearing into the base body. By this, it is prevented that product residues or cleaning fluid may penetrate into the base body or into the machine base.

According to one embodiment, the base body has a first outer end face in the transport direction and a second outer end face, which is opposite to first outer end face. The pivot bearings of the adjacent transport units are arranged on the first end face and on the second end face. The base body may be the base body of the transport device or of the separating device.

According to one embodiment, two adjacent transport units are arranged on each end face. The transport direction thereby preferably extends from the second end face to the first end face.

The invention has previously been described with reference to a transport device. In a further aspect, the invention relates to a separating device for separating portions made of elongated casings filled with food mass, in particular sausage portions made of a string of sausage portions, having a transport device and a separating element, which is equipped to separate sausage portions connected to one another in a string of sausages.

The invention solves the problem designated at the outset with respect to the separating device, in which the transport device is designed as described herein.

The separating device exploits the same advantages and preferred embodiments as the transport device according to the invention and vice versa. To avoid repetitions, reference is made to the above argument. The use of the transport devices for a separating device has thereby proven to be particularly advantageous. As a whole, it is achieved that a string of sausage portions is securely guided to the separating element, and additionally the individual portions are transported away from the separating element, a secure transport being ensured even in the case of deviations in caliber and deviations in shape, and the device being particularly hygienic overall and easy to clean.

According to one embodiment, the transport device is a first transport device, the separating device having a second transport device according to the description above, and the second transport device being downstream in the transport direction of the first transport device, and the separating element being arranged between the first and the second transport devices. In a separating device of this type, two adjacent transport units are preferably arranged in each case on each end face of the base body of the separating device. The base body of the transport device is thereby simultaneously the base body of the separating device.

According to a second aspect of the invention or according to one advantageous refinement of the invention according to the first aspect, it is proposed in relation to the separating device according to the invention that the at least one transport device is arranged laterally on a base body of the separating device by at least one pivot bearing, the separating element being directly coupled to a drive motor which is arranged at the top in the base body adjacent to the transport belts of the transport device.

The refinement or the second aspect of the invention in relation to the separating device arises from the prior art, in which a rotating knife with multiple blades is used as a separating element for the separation of small sausages. Due to high demands on the dynamics, the separating device or the knife is directly connected to a drive motor, i.e., optionally with the interposition of a shaft, however, without further transmission, such as gears or the like. These types of separating elements are designed so that a smallest possible mass inertia is achieved. This is therefore necessary, as such a separating element is intermittently operated, i.e., it is rotated in the circumferential direction for the purpose of a cutting process, precisely when a twist-off point is present in the area of the separating element.

In devices previously known from the prior art, the corresponding drive components or housing mountings for the relevant transport belts are located underneath the transport belts. Therefore, it is necessary in the prior art to space the drive motor away from these mechanical components. As a result, due to the direct coupling of the separating element with the drive motor, the separating element has to have a correspondingly large diameter. This is accompanied by a resulting mass inertia of the separating element, said mass inertia consequently limiting the separation performance, i.e., the separation speed per time unit. This also means that the production throughput is limited per time unit.

Due to the arrangement of the pivot bearing of the transport device(s) laterally on the base body in the way described here according to the invention, installation space at the top within the housing is now available, which may therefore be used to accommodate the drive motor. As, by this, the spacing between the axis of rotation of the separating element and the transport belts or the corresponding receiving space for the sausage portions or the string of sausages is also reduced, the diameter of the separating element may be reduced. In other words, the motor is thus arranged closer to the transport area of the strings of sausages.

The reduction in diameter facilitates the acceleration and deceleration of the separating element within a shorter time, by which the cutting performance of the separating device may be increased per time unit. It is possible by this to feed a string of sausages to the separating device and to separate the string of sausages into sausage portions at higher speed. This has also proven advantageous in relation to the controller. Furthermore, due to its lowered mass inertia, the separating device is distinguished by an advantageous overshoot behavior, an improved acceleration and deceleration behavior, and also improved dynamic properties overall. Moreover, despite the increased separation performance, the motor power may be reduced with respect to known solutions from the prior art due to the lower inertia of the separating element.

According to one embodiment, the separating element has a diameter transverse to its axis of rotation of ≤200 mm, in particular ≤180 mm, in particular wherein the diameter of the separating element is greater than 120 mm. The use of separating elements with diameters less than or equal to 200 mm is initially possible in that the mechanical components for operating the transport devices have now been displaced from the installation area of the drive motor. A minimum diameter greater than 120 mm is necessary in order to be able to implement secure separating procedures.

According to one embodiment, the separating element is designed as a rotatable knife. The knife is preferably designed as a symmetrical knife which has two blades. The use of this type of knife with two blades is implementable due to the lower inertia due to the lower necessary diameter for the knife. In the case that the knife is designed to be symmetrical, a total of two edges may be designed on the respective blades. In this way, the cutting process may be accomplished in both rotational directions. By this, such a knife may remain in production longer until resharpening is necessary.

According to one embodiment, the blade is designed in such a way that this is mountable to be rotated by 180° along its longitudinal axis. Even in the case, that a fixed rotational direction is provided for the cutting process, the service life of the knife may be increased by rotation, as, after blunting the blades in a first installation direction, the knife may be removed, may be rotated by 180° along its longitudinal axis, and then, following a corresponding installation, the reserved sharp blades may be used for further separating processes. The drive motor is preferably designed as a servomotor.

According to one embodiment, the axis of rotation of the drive motor is arranged coaxially to the axis of rotation of the separating element. This is preferable due to the high dynamic demands, which arise from the intermittent operation of the separating element, among other things. The drive motor is preferably operated in so-called cyclic operation, i.e., the separating element is only rotated when a separation point of the string of sausages is located in the area of the separating element.

In a further aspect, the invention additionally relates to a method for operating a transport device or a separating device according to one of the preceding exemplary embodiments. According to the invention, the method has the steps: adjusting an outlet spacing between the adjacent transport belts, in particular by a stop, the outlet spacing being selected to be smaller than the smallest expected diameter of the portions of the string of sausages to be transported; transporting the portions or the string of sausages in a receiving space between the adjacent transport belts. Due to the relevant adjustment of the outlet spacing between the adjacent transport belts, a sufficiently large force is applied for transporting the portions to be transported on the one hand, such that the transport belts do not slip and ultimately no slippage occurs, and additionally no unnecessary load occurs on the transport belt pair and the mechanical components, so that a service life of these components is increased.

The method is further refined by the steps: pivoting of the transport units about the axes of rotation into a cleaning position, in which the spacing between the adjacent transport belts is increased; cleaning of at least one transport device or of the separating device. In this way, the area under the transport belts is open and thoroughly cleanable. In the cleaning position, the access to the under side of the transport units is further improved. The method makes use of the same advantages and preferred embodiments as the transport device according to the invention and the separating device according to the invention and vice versa. To avoid repetitions, reference is made to the above argument and this is included here.

In a further aspect, the invention relates to the use of a transport device according to one of the preceding exemplary embodiments for a separating device, in particular for feeding and/or discharging sausage portions or a string of sausages to and/or away from a separating element.

The method also makes use of the same advantages and preferred embodiments as the transport device according to the invention and the separating device according to the invention and vice versa.

### BRIEF DESCRIPTION OF THE DRAWINGS

Further features and advantages of the invention arise from the subsequent description, in the exemplary embodiments explained in greater detail by way of the schematic drawings.

FIG. 1 is a perspective view of one exemplary embodiment of a separating device according to the invention having a storage table.

FIG. 2a is another perspective view of the exemplary embodiment of the separating device according to FIG. 1.

FIG. 2b illustrates further components of the exemplary embodiment of the separating device according to FIG. 1.

FIG. 3 is a perspective view of the exemplary embodiment of the separating device thereof with a partially open housing.

FIGS. 4a and 4b illustrate the exemplary embodiment of the separating device thereof in different operating positions.

FIGS. 5a-5c illustrate different operating positions of the exemplary embodiment of the separating device thereof.

FIG. 6 is a perspective view of an alternative exemplary embodiment of a separating device according to the invention.

FIGS. 7a and 7b are perspective views of the exemplary embodiment of the separating device according to FIG. 6.

FIG. 8 is a flowchart showing a block diagram of a method according to embodiments of the invention.

### DETAILED DESCRIPTION

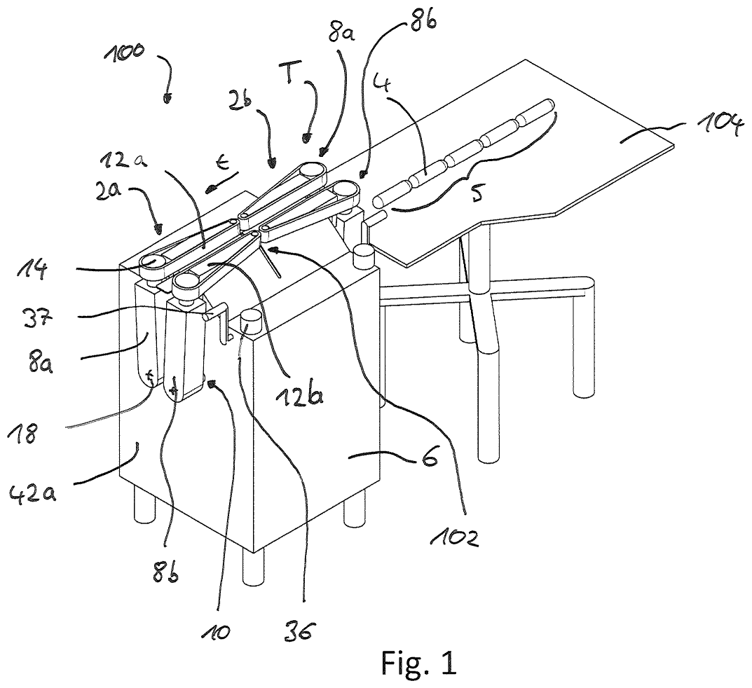

FIG. 1 shows a separating device 100 for separating portions 4 made of elongated casings filled with food mass, in particular sausage portions 4 from a string 5 of sausage portions 4. A storage table 104 is arranged adjacent to separating device 100, on which storage table a string 5 of this type made of sausage portions 4 is schematically depicted. Separating device 100 has a first transport device 2a and a second transport device 2b. Second transport device 2b is arranged in a transport direction t downstream from first transport device 2a. Separating device 100 furthermore has a separating element 102. Separating element 102 is arranged between first and second transport devices 2a, 2b.

Separating device 100 has a base body 6. Base body 6 is simultaneously the base body of transport devices 2a, 2b. Base body 6 is also designated as machine base 6 and has, in particular, a pyramid shape on its top side. Each of transport devices 2a, 2b has two transport units 8a, 8b. Transport units 8a, 8b are each connected to the base body via a bearing 10. Transport units 8a, 8b each have a drivable transport belt 12a, 12b. Transport belt belts 12a, 12b are driven via drive rollers 14. Transport belt belts 12a, 12b of transport units 8a, 8b are thereby arranged adjacent to one another in such a way that these define a receiving space 16 between themselves for receiving and transporting portions 4 or a string 5 made of sausage portions 4 in transport direction t.

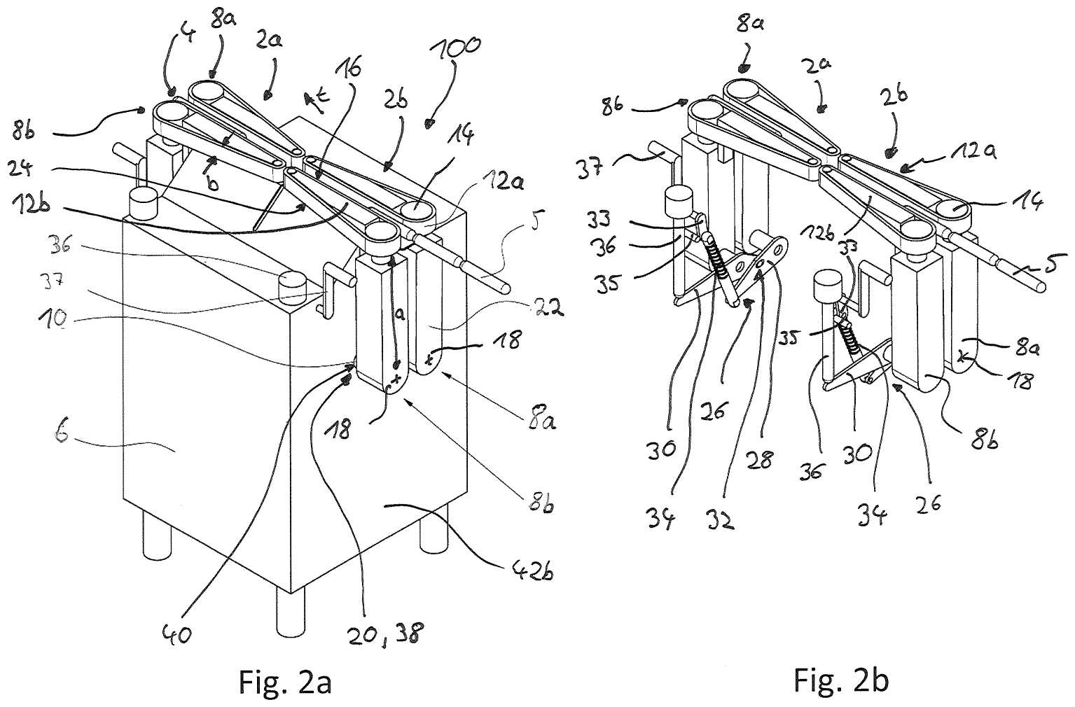

Bearings 10 of respective transport devices 2a, 2b are designed as pivot bearings 10. Pivot bearings 10 respectively have an axis of rotation 18, about which associated transport belt unit 8a, 8b is mounted to be pivotable with respect to base body 6. Adjacent transport belts 12a, 12b of transport units 8a, 8b are movable toward one another and/or away from one another by the pivoting about axes of rotation 18. Transport units 8a, 8b of both transport devices 2a, 2b are arranged adjacent to one another. Axes of rotation 18 of adjacent transport units 8a, 8b are thereby arranged parallel to one another. A drive motor 20 is thereby assigned to each of transport units 8a, 8b, the drive motor being, in particular, embedded into base body 6. Transport units 8a, 8b respectively have an arm section 22, which is depicted in FIG. 2a. Arm section 22 spaces respective transport belts 12a, 12b apart from relevant pivot bearing 10. The spacing is selected in such a way that, despite the pivot bearing, a lowest possible angular error occurs in the area of transport belts 12a, 12b. A spacing a between axis of rotation 18 of pivot bearing 10 and a lower edge 24 of assigned transport belt 12a, 12b is preferably 2 to 50 times width b of transport belt 12a, 12b.

As shown in FIG. 2b, adjacent transport units 8a, 8b are coupled to one another via a coupling device 26. A biasing element 34, which is designed in FIG. 2b as a compression spring, is assigned to coupling device 26. Biasing element 34 is equipped to bias coupled transport units 8a, 8b in the direction of receiving space 16. Biasing element 34 ensures that sausage portions 4 to be transported are pressed against transport belts 12a, 12b with a defined force and may be transported. Deviations of sausage portions 4 with respect to caliber and shape may thus be compensated for and slippage-free transport may be guaranteed.

Coupling device 26 is designed in such a way that a first arm section 28 is connected to first transport belt unit 8a. A second arm section 30 is connected to second transport belt unit 8b. First arm section 28 is coupled to second arm section 30 via a connecting link guide 32. If, as is depicted in FIG. 2b, biasing element 34 is coupled to first arm section 28, then the biasing force applied hereby may also be transferred via connecting link guide 32 to second arm section 30, which is connected to second transport belt unit 8b.

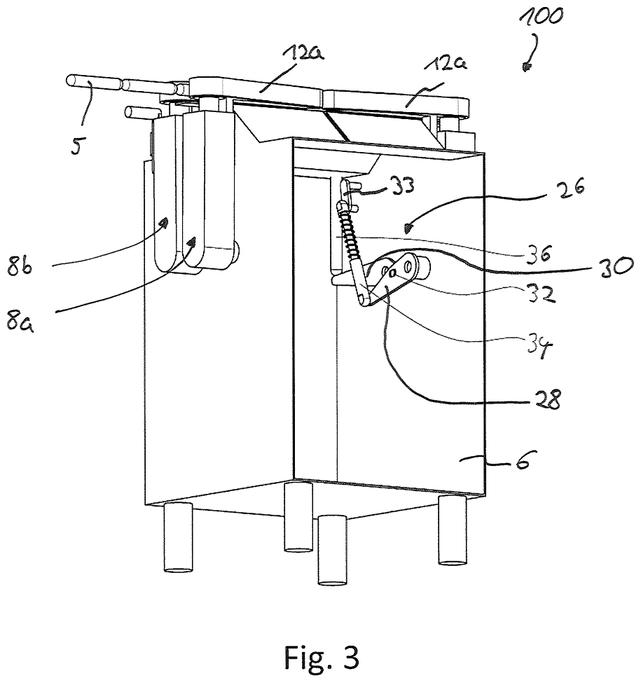

Coupling device 26 additionally has an adjustable stop 36. Adjustable stop 36 is equipped to adjust an outlet spacing da of transport belts 12a, 12b to one another. For this purpose, adjustable stop 36 acts on second arm section 30. Depending on a vertical position of a lower end of adjustable stop 36, outlet spacing da of transport belts 12a, 12b is adjusted with respect to one another. The adjustment is to be carried out in such a way that spacing da is slightly smaller than the smallest diameter to be expected for sausage portions 4 to be transported. Separating device 100 has a base body 6. Base body 6 has a first outer end face 42a in transport direction t and a second outer end face 42b, which is opposite to first outer end face 42a. Pivot bearings 10 of adjacent transport units 8a, 8b are arranged on first end face 42a and on second end face 42b. FIG. 3 shows coupling device 26 from another perspective view.

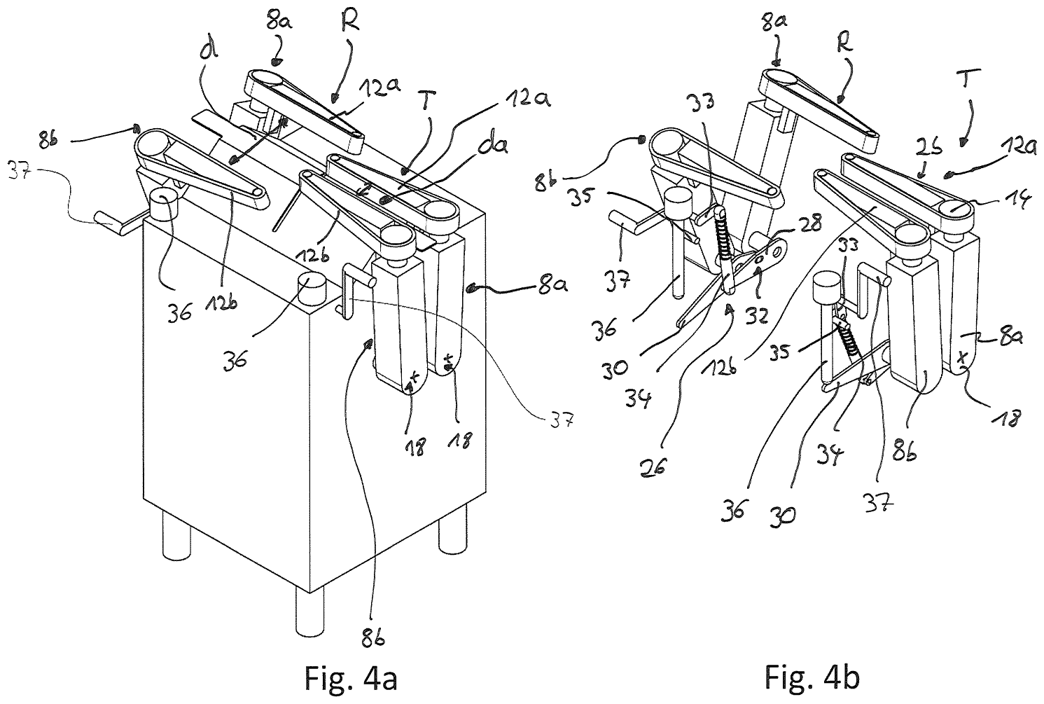

By pivoting about axis of rotation 18, transport units 8a, 8b are, as is shown in FIGS. 4a and 4b, pivotable away from one another out of a transport position T, which is shown in FIGS. 4a and 4b for second transport unit 8b, into a cleaning position R. Cleaning position R, in relation to first transport belt unit 8a, is shown in FIGS. 4a and 4b. A spacing d between adjacent transport belts 12a, 12b is increased in cleaning position R. A crank 37, which acts on coupling device 26, is provided for pivoting between cleaning position R and transport position T. This is designed in the exemplary embodiment shown in FIG. 4b in such a way that spring 34 is connected to crank 37 via an intermediate segment 33. An actuation of crank 37 acts via intermediate segment 33 on spring 34, and from there on first arm section 28. The actuation of crank 37 additionally acts on second arm section 30 via connecting link guide 32, such that the actuation of crank 37 into the position shown in FIG. 4b in relation to first transport belt unit 8a results in that a spacing d is increased between adjacent transport belts 12a, 12b. By actuating crank 37 into the position shown in FIG. 4b in relation to second transport device 2b, second transport device 2b is transferred into transport position T. In this case, intermediate segment 33 contacts limit pin 35.

The transport devices additionally have respective sealing elements 38, which seal a feed through 40 of pivot bearing 10 into base body 6. By this, it is ensured that no cleaning fluid or product residues may penetrate into base body 6, and at the same time a lowest possible rotational inertia is ensured in the area of pivot bearings 10, such that transport units 8a, 8b may adapt to the shape of sausage portions 4 to be transported in the manner described.

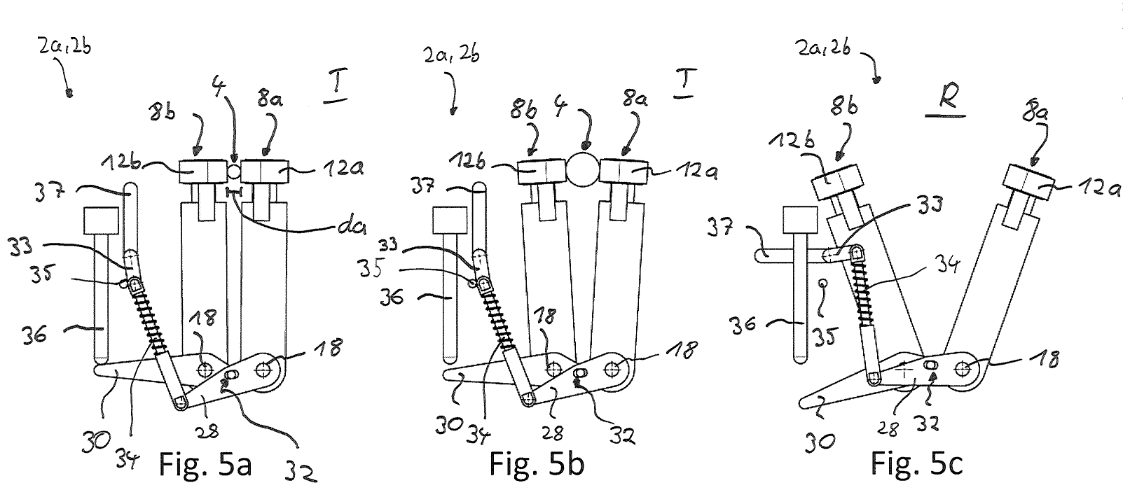

FIGS. 5a to 5c illustrate the different operating positions of separating device 100 or transport devices 2a, 2b. In the state shown in FIG. 5a, an outlet spacing da of transport belts 12a, 12b is adjusted with respect to one another via adjustable stop 36. Said outlet spacing is selected, in particular, in such a way that outlet spacing da is slightly smaller than the smallest diameter to be expected for sausage portions 4 to be transported.

In the state shown in FIG. 5b, a sausage portion 4 is now being transported, which has a larger diameter due to deviations in shape and/or caliber. As a result, transport units 8a, 8b are deflected outward against a spring force of spring 34, however, they still apply a sufficient force between transport units 8a and 8b and sausage portion 4, such that a secure transport of sausage portion 4 is guaranteed. At the same time, it is prevented that the mechanical components of transport units 8a and 8 are unduly burdened or that any blockage of transport belts 12a, 12b occurs, which is achieved, in particular, in that transport belts 12a, 12b may deflect to the outside.

Respective transport devices 2a, 2b are located in FIGS. 5a and 5b in transport direction T. In FIG. 5c, transport devices 2a, 2b are located in cleaning position R. For this purpose, crank 37 in FIG. 5c is pivoted with respect to FIGS. 5a, 5b, and acts via intermediate segment 33 and spring 34 on first arm section 28, and from there via connecting link guide 32, by which transport units 8a, 8b are kinematically coupled, also on second arm section 30. In cleaning position R, shown in FIG. 5c, the spacing between transport belts 12a, 12b is increased.

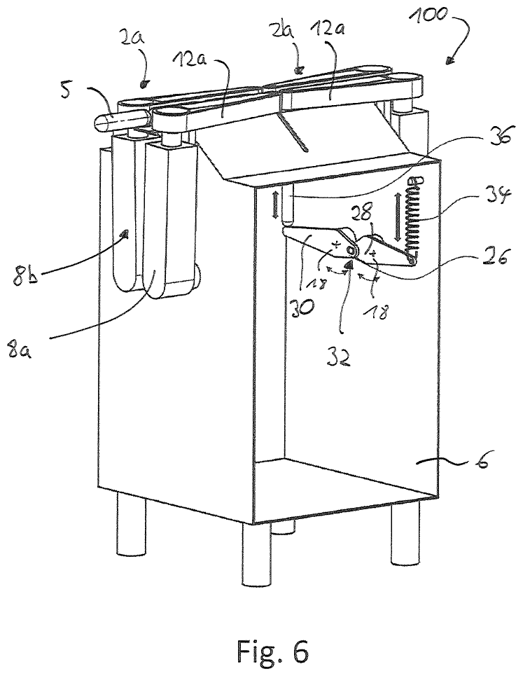

FIG. 6 shows an alternative exemplary embodiment of a separating device 100. This has, as in the previously described manner, two transport devices 2a, 2b, which are designed analogously to transport devices 2a, 2b from FIGS. 1 to 5. However, coupling device 26 is configured differently. An arm section 28, 30 is respectively connected to respective axes of rotation 18 of transport units 8a, 8b. However, arm sections 28, 30 are connected to one another via a connecting link guide 32 in an area between axes of rotation 18. Adjustable stop 36 acts on second arm section 30. First arm section 28 is connected to the housing using a spring 34. Spring 34 acts in this case as a tension spring. Spring 34, shown in FIGS. 1 to 5, acts as a compression spring.

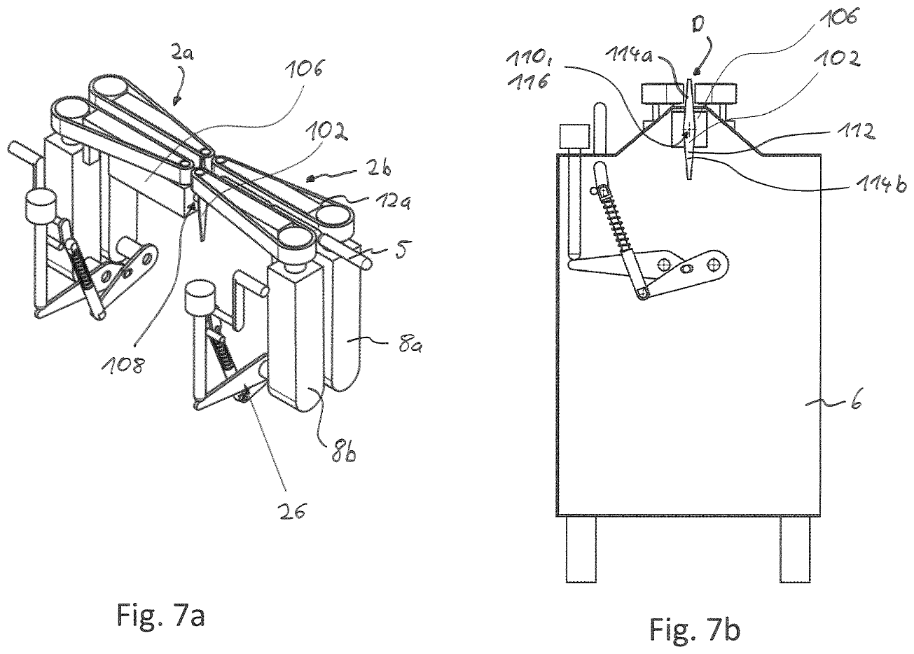

FIGS. 7a and 7b show separating device 100 according to the invention. As is illustrated in the figures, transport devices 2a, 2b are respectively arranged via two pivot bearings 10, as described in the remaining figures, laterally on a base body 6 of separating device 100 as shown in FIG. 7b. Separating element 102 is directly coupled to a drive motor 106, i.e., in this case merely by the interposition of a short drive shaft. Drive motor 106 is arranged at the top in base body 6 adjacent to transport belts 12a, 12b of transport device 2a. As is particularly clear from FIG. 7b, drive motor 106 is adjacent to the upper side of base body 6 and is thus located in direct proximity to transport belts 12a, 12b. In this way, a diameter D of separating element 102 may be reduced with respect to the solutions known from the prior art. In particular, separating element 102 has a diameter D transverse to its axis of rotation 110 of ≤200 mm, in particular ≤180 mm. Diameter D of separating element 102 is preferably greater than 120 mm. Separating element 102 is designed as a rotatable knife 112. Knife 112 is designed, in particular, as symmetrical. Knife 112 has two blades 114a, 114b. Each blade 114a, 114b preferably has two cutting edges, the one cutting edge facing in the direction of rotation and one cutting edge facing in the opposite direction. Symmetrical knife 112 may preferably be mounted both in the position depicted in FIG. 7b and also in a position rotated by 180° along the longitudinal axis, such that the additional cutting edge may then be used for the separating process. As depicted, axis of rotation 116 of drive motor 106 is arranged coaxially to axis of rotation 110 of separating element 102. A direct connection of this type between separating element 102 and drive motor 106, which merely requires the interposition of a short drive shaft, further reduces the mass inertia of separating element 102 and improves its dynamic properties. Separating element 102 is preferably operated intermittently, i.e., preferably only when a string of sausages 5 is positioned relative to separating element 102 in such a way that separating element 102 may cut the connecting region between two sausage portions 4. Due to smaller diameter D of separating element 102, in comparison to the prior art, a larger number of sausage portions 4 from one string of sausages 5 may be separated in a given time, as, in particular, the acceleration and deceleration of separating element 102 may be carried out faster, more dynamically, and also more precisely due to the lower mass inertia.

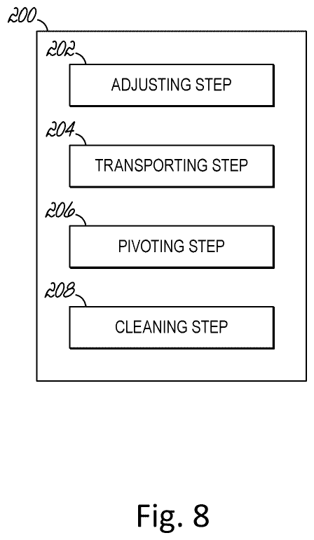

FIG. 8 schematically shows a method 200 for operating a transport device 2a, 2b or a separating device 100. Method 200 has the steps: adjusting 202 an outlet spacing da between adjacent transport belts 12a, 12b, in particular by a stop 36, outlet spacing da being selected to be smaller than the smallest expected diameter of portions 4 or of string of sausages 5 to be transported; transporting 204 of portions 4 or string of sausages 5 in a receiving space 16 between adjacent transport belts 12a, 12b; pivoting 206 of transport units 8a, 8b about axes of rotation 18 into a cleaning position R, in which the spacing d between adjacent transport belts is increased; cleaning 208 of at least one transport device 2a, 2b or of separating device 100.

1. A transport device for transporting portions made of elongated casings filled with food mass, the transport device comprising:
a base body,
two transport units being respectively connected to the base body via a bearing, and the transport units respectively having a drivable transport belt,
the transport belts being arranged adjacent to one another in such a way to define a receiving space therebetween for receiving and transporting the portions in a transport direction,
wherein at least one bearing is designed as a pivot bearing, the at least one pivot bearing having an axis of rotation about which the respective transport belt unit is mounted to be pivotable with respect to the base body, and the transport belts are movable toward one another and away from one another by pivoting about the axis of rotation.

2. The transport device of claim 1, wherein the pivot bearings are arranged laterally on the base body.

3. The transport device of claim 1, wherein the transport units are arranged adjacent to one another, and wherein axes of rotation of the adjacent transport units are arranged parallel to one another.

4. The transport device of claim 1, wherein the transport units each have an arm section, which spaces the transport belt away from the pivot bearing, and wherein a spacing between the axis of rotation of the pivot bearing and a lower edge of the assigned transport belt is 2 to 50 times a width of the transport belt.

5. The transport device of claim 3, wherein the adjacent transport units are coupled to one another via a coupling device.

6. The transport device of claim 5, wherein a biasing element assigned to the coupling device is equipped to bias the coupled transport units in the direction of the receiving space.

7. The transport device of claim 5, wherein the coupling device has an adjustable stop which is equipped to adjust an outlet spacing of the transport belts to one another.

8. The transport device of claim 5, wherein the transport units, by pivoting away from one another about the axes of rotation, are pivotable out of a transport position into a cleaning position in which a spacing between the adjacent transport belts is increased, and wherein a crank is provided, which acts on the coupling device for pivoting between the cleaning position and the transport position.

9. The transport device of claim 1, wherein the transport device has a sealing element, which seals a feed through of the pivot bearing into the base body.

10. The transport device of claim 1, wherein the base body has a first outer end face in the transport direction and a second outer end face, which is opposite the first outer end face, and wherein the pivot bearings of the adjacent transport units are arranged laterally on the base body on at least one of the first end face and the second end face.

11. A separating device for separating portions made of elongated casings filled with food mass, the separating device comprising:
the transport device of claim 1, and
a separating element, which is equipped to separate sausage portions connected to one another in a string of sausages.

12. The separating device of claim 11, wherein the transport device is a first transport device, and wherein the separating device has a second transport device, wherein the second transport device is downstream of the first transport device in the transport direction, and
wherein the separating element is arranged between the first and the second transport devices.

13. The separating device of claim 12, wherein each of the transport devices is arranged laterally on a base body of the separating device by at least one pivot bearing, and
wherein the separating element is directly coupled to a drive motor, which is arranged at the top in the base body adjacent to the transport belts of the transport devices.

14. The separating device of claim 13, wherein the separating element has a diameter transverse to its axis of rotation that is less than or equal to 200 mm and is greater than 120 mm.

15. The separating device of claim 13, wherein the separating element is designed as a rotatable and symmetrical knife which has two blades,
wherein an axis of rotation of the drive motor is arranged coaxially to the axis of rotation of the separating element.

16. A method for operating the transport device of claim 1 having the steps:
adjusting an outlet spacing between the adjacent transport belts, by a stop, the outlet spacing being selected to be smaller than a smallest expected diameter of the portions or of a string of sausages to be transported,
transporting the portions or the string of sausages in a receiving space between the adjacent transport belts.

17. The method of claim 16, further comprising the steps:
pivoting the transport units about the axes of rotation into a cleaning position, in which the spacing between the adjacent transport belts is increased,
cleaning the at least one transport device or the separating device.
